(19) United States
(12) Patent Application Publication
(10) Pub. No.: US 2026/0257293 A1
(43) Pub. Date: Sep. 3, 2026

(54) REFLOW OVEN

(71) Applicant: Illinois Tool Works Inc., Glenview, IL (US)

(72) Inventors: Binhua YU, Suzhou (CN); Weizhou LIU, Suzhou (CN)

(21) Appl. No.: 18/833,229

(22) PCT Filed: Jan. 17, 2023
(86) PCT No.: PCT/US2023/060766

§ 371 Date: Jul. 25, 2024

(30) Foreign Application Priority Data
Jan. 27, 2022 (CN) 202210101867.0

(51) Int. Cl. B23K 3/08; B23K 1/008; B23K 3/04; B23K 101/42

(52) U.S. Cl. CPC B23K 3/08; B23K 1/008; B23K 3/04; B23K 2101/42

(57) ABSTRACT

The present application discloses a reflow oven including: a furnace chamber; at least one negative pressure heating unit, each negative pressure heating unit including a negative pressure heating unit upper portion and a negative pressure heating unit lower portion; and a plurality of delivery channel sub-regions, where the negative pressure heating unit upper portion includes an upper fan (219), an upper suction channel (332), and an upper exhaust channel (334); the negative pressure heating unit lower portion includes a lower fan (220), a lower suction channel (333), and a lower exhaust channel (331); gas discharged from the lower fan exhaust port (335) flows through the lower exhaust channel and blows to the middle region of the delivery channel sub-region, then is sucked by the upper suction channel and delivered to the upper fan suction port (338), and the gas discharged from the upper fan exhaust port sequentially flows through the upper exhaust channel, the side regions of the delivery channel sub-region and the lower suction channel, and is then received by the lower fan suction port. In the reflow oven of the present application, when the circuit board is in the negative pressure heating unit, the gas above the circuit board forms a negative pressure to facilitate expelling of hollows in the soldering paste of the circuit board.

### TECHNICAL FIELD

The present application relates to a reflow oven, and in particular to a reflow oven for circuit board soldering.

### BACKGROUND

In the production of printed circuit boards, electronic elements are typically mounted to circuit boards using a process called “reflow soldering.” In a typical reflow soldering process, a soldering paste (e.g., tin paste) is deposited into a selected area on a circuit board and a wire of one or more electronic elements is inserted into the deposited soldering paste. The circuit board then passes through a reflow oven in which the soldering paste refluxes (i.e., is heated to a melting or reflux temperature) in a heating area and then cools in a cooling area to form solder joints electrically and mechanically connecting the wires of the electronic elements to the circuit board. As used herein, the term “circuit board” comprises a substrate assembly of any type of electronic element, such as comprises a wafer substrate.

During the soldering process, the soldering paste may cause gas to entrain inside the soldering paste after heating, resulting in hollows inside the solder joint after the soldering paste cools, affecting the reliability of the solder joint, resulting in performance defects of the solder product.

### SUMMARY

At least one object of the present application is to provide a reflow oven including: a furnace chamber, several heating units and a delivery channel. The several heating units are disposed side-by-side in the furnace chamber along a first direction, the several heating units including at least one negative pressure heating unit, each negative pressure heating unit including a negative pressure heating unit upper portion and a negative pressure heating unit lower portion. The delivery channel extends through the plurality of heating units along the first direction and includes a plurality of delivery channel sub-regions respectively located between the negative pressure heating unit upper portion and the negative pressure heating unit lower portion of each negative pressure heating unit. The delivery channel sub-regions includes in a second direction perpendicular to the first direction a middle region for passing a processing element through and side regions located on opposite sides of the middle region. The negative pressure heating unit upper portion includes an upper fan, an upper suction channel, and an upper exhaust channel, the upper fan having an upper fan suction port and an upper fan exhaust port; the negative pressure heating unit lower portion includes a lower fan, a lower suction channel, and a lower exhaust channel, the lower fan having a lower fan suction port and a lower fan exhaust port. The upper suction channel, the upper exhaust channel, the lower suction channel, and the lower exhaust channel are configured such that gas discharged from the lower fan exhaust port flows through the lower exhaust channel and blows to the middle region of the delivery channel sub-region, then is sucked by the upper suction channel and delivered to the upper fan suction port, and the gas discharged from the upper fan exhaust port sequentially flows through the upper exhaust channel, the side regions of the delivery channel sub-region and the lower suction channel, and is then received by the lower fan suction port.

According to the above description, the negative pressure heating unit upper portion and the negative pressure heating unit lower portion of each negative pressure heating unit and the delivery channel sub-region located between the negative pressure heating unit upper portion and the negative pressure heating unit lower portion collectively form a heated gas internal circulation passage; where the heated gas internal circulation passage includes a backward passage for heated gas to flow from bottom to top and a forward passage for the heated gas to flow from top to bottom, where the backward passage includes the lower exhaust channel, the middle region of the delivery channel sub-region and the upper suction channel, and the forward passage includes the upper exhaust channel, the side regions of the delivery channel sub-region and the lower suction channel.

According to the above description, the furnace chamber includes a preheating zone and a peak zone, and the several heating units are disposed in the preheating zone and the peak zone, where the at least one negative pressure heating unit is disposed in the peak zone.

According to the above description, the pressure within the negative pressure heating unit upper portion is −0.001 to −0.01 atmospheric pressure.

According to the above description, the negative pressure heating unit upper portion includes an upper housing and an upper divider. The upper divider is disposed within the upper housing, the upper fan suction port and the upper fan exhaust port are disposed within the upper housing, the upper suction channel and the upper exhaust channel are formed by the upper divider and the upper housing, the inlet of the upper suction channel is located directly above the middle region of the delivery channel sub-region; the negative pressure heating unit lower portion includes a lower housing and a lower divider disposed within the lower housing, and the lower fan suction port and the lower fan exhaust port are disposed within the lower housing, the lower suction channel and the lower exhaust channel are formed by the lower divider and the lower housing, the outlet of the lower exhaust channel is located directly below the middle region of the delivery channel sub-region.

According to the above description, the upper fan suction port is located directly above the middle region of the delivery channel sub-region, and there is no upper divider between the upper fan suction port and the middle region of the delivery channel sub-region.

According to the above description, the upper housing of the negative pressure heating unit upper portion includes a pair of first direction side walls extending in the first direction, a pair of second direction side walls extending in the second direction, and an upper top wall, the first direction upper side walls, the second direction upper side walls and the upper top walls being connected to each other such that the upper housing forms a box body shape with a bottom opening. The upper top wall has a fan receiving port. the upper divider includes a transverse partition and a pair of vertical partitions located below the transverse partitions and connected to both ends of the transverse partition in the second direction, the transverse partition having an upper fan opening; where the transverse partition and the pair of vertical partitions are all connected to the pair of second direction upper side walls to collectively form the upper suction channel through the transverse partition, the pair of vertical partitions and the pair of second direction upper side walls, the upper fan opening forming an outlet of the upper suction channel; where the transverse partition is spaced from the upper top wall by a certain distance to form a part of the upper exhaust channel, and the pair of vertical partitions are spaced from the pair of first direction upper side walls by a certain distance, respectively, to form another part of the upper exhaust channel.

According to the above description, the upper fan suction port is connected to an upper fan opening of the transverse partition, and the upper fan exhaust port is disposed between the transverse partition and the upper top wall and is in communication with the upper exhaust channel.

According to the above description, the upper housing includes a housing insertion port disposed on one of the pair of first direction upper side walls; the upper divider further includes a pair of heating element insertion ports and a pair of spacer retainers; the pair of heating element insertion ports are disposed on the pair of vertical partitions, respectively; the pair of spacer retainers are disposed around the pair of heating element insertion ports respectively and between the pair of vertical partitions and the first direction upper side walls to isolate the upper suction channel and the upper exhaust channel while being able to receive a heating element.

According to the above description, the lower housing of the negative pressure heating unit lower portion includes a pair of first direction lower side walls extending in the first direction, a pair of second direction lower side walls extending in a second direction, and a lower bottom wall, the first direction lower side walls, the second direction lower side walls and the lower bottom wall being connected to each other such that the lower housing forms a box body shape with a top opening. The bottom of the partition box body has a lower fan opening. The lower divider includes a partition box body and a pair of partition flanges, the partition box body having a pair of box body openings at both ends in the second direction, the pair of partition flanges disposed around and extending outwardly from the pair of box body openings respectively, the bottom of the partition box body having a lower fan opening; the pair of partition flanges are connected to the pair of second direction lower side walls and the lower bottom wall, respectively, and are spaced from the pair of first direction lower side walls by a certain distance to form a part of the lower suction channel, another part of the lower suction channel being formed inside the partition box body, and the lower fan opening forming an outlet of the lower suction channel; and the partition box body is spaced apart from the lower bottom wall and the pair of second direction lower side walls to form the lower exhaust channel between the pair of partition flanges, the partition box body and the lower housing.

According to the above description, the lower housing includes a housing insertion port. The housing insertion port is disposed on one of the pair of first direction lower side walls; and the housing insertion port and the pair of box body openings are provided to collectively receive a heating element.

According to the above description, the lower fan suction port is connected to a lower fan opening of the partition box body, and the lower fan exhaust port is disposed between the partition box body and the lower bottom wall and in communication with the lower exhaust channel.

Other objects and advantages of the present application will be apparent from the description of the present application hereinafter with reference to the accompanying drawings, and may help with a full understanding of the present application.

### BRIEF DESCRIPTION OF DRAWINGS

FIG. 1 is a schematic diagram of a reflow oven in accordance with an embodiment of the present application;

FIG. 2A is a perspective view of the front side of two negative pressure heating units in the reflow oven shown in FIG. 1;

FIG. 2B is a perspective view of the rear side of two negative pressure heating units in the reflow oven shown in FIG. 1;

FIG. 2C is a top view of two negative pressure heating units in the reflow oven shown in FIG. 1;

FIG. 2D is an exploded view of two negative pressure heating units in the reflow oven shown in FIG. 1;

FIG. 3A is a cross-sectional view of the two negative pressure heating units of FIG. 2A along the A-A line;

FIG. 3B is a cross-sectional view of the two negative pressure heating units of FIG. 2A along the B-B line;

FIG. 4 is a perspective view of an upper fan of FIG. 2A;

FIGS. 5A and 5B are schematic structural diagrams of a soldering paste with hollows;

FIG. 6A is a perspective view of a heating unit upper portion of FIG. 2A;

FIG. 6B is a perspective view of the heating unit upper portion of FIG. 6A viewed from bottom up;

FIG. 6C is an exploded view of the heating unit upper portion of FIG. 6A viewed from top down;

FIG. 6D is an exploded view of the heating unit upper portion of FIG. 6A viewed from bottom up;

FIG. 7A is a perspective view of the heating unit lower portion of FIG. 2A;

FIG. 7B is a perspective view of the heating unit lower portion of FIG. 7A viewed from bottom up;

FIG. 7C is an exploded view of the heating unit lower portion of FIG. 7A viewed from top down;

FIG. 7D is an exploded view of the heating unit lower portion of FIG. 7A viewed from bottom up.

### DETAILED DESCRIPTION

Various specific embodiments of the present application will be described below with reference to the attached drawings that form a part of the present specification. It should be understood that while terms denoting orientation, such as “front,” “rear,” “upper,” “lower,” “left,” “right,” “top,” “bottom,” “inside,” “outside,” “front side,” “rear side” etc., are used in the present application to describe various exemplary structural parts and elements of the present application, these terms are used herein for convenience of illustration only and are determined based on the exemplary orientations shown in the attached drawings. Since the embodiments disclosed in the present application may be disposed in different orientations, these terms denoting orientation are for illustrative purposes only and should not be considered as limiting.

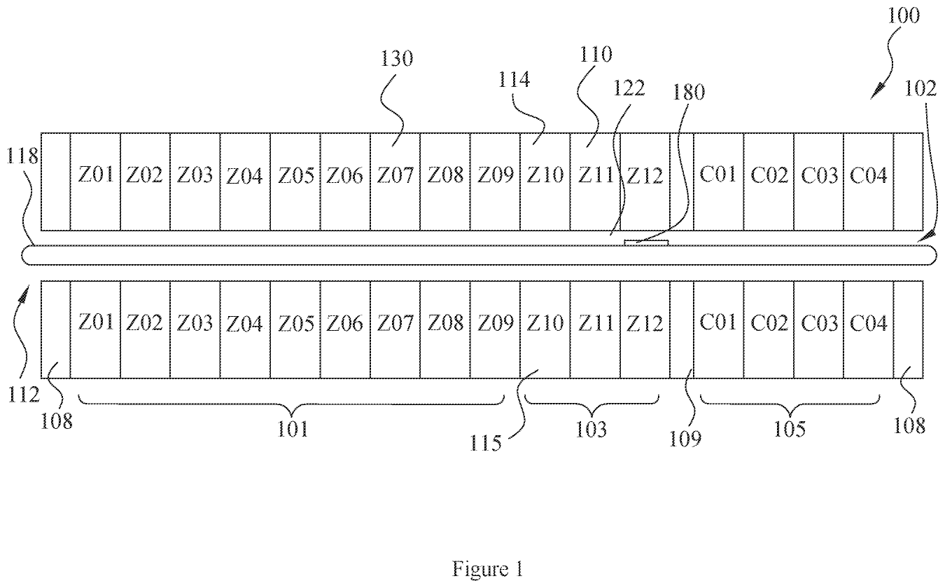

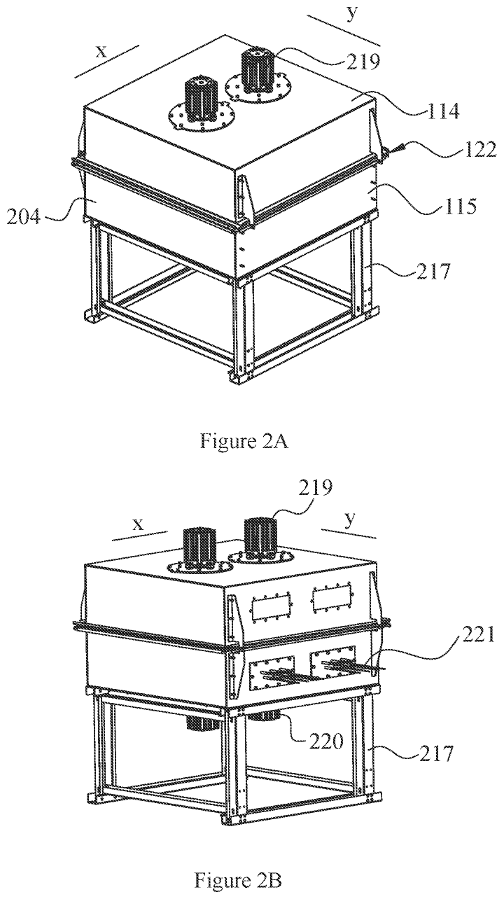

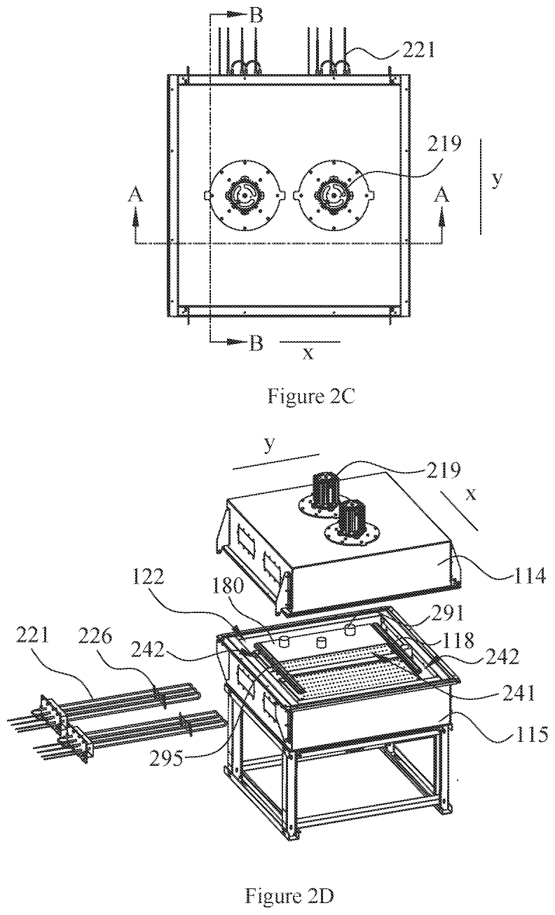

FIG. 1 is a simplified schematic diagram of an embodiment of a reflow oven 100 according to an embodiment of the present application, which is an embodiment of the reflow oven of the present application. As shown in FIG. 1, the reflow oven 100 includes a furnace chamber 112 and a preheating zone 101, a peak zone 103, and a cooling zone 105 disposed within the furnace chamber 112, the preheating zone 101, the peak zone 103, and the cooling zone 105 being disposed sequentially along a first direction x. The reflow oven 100 also includes a delivery channel 102 and a delivery device 118. The delivery channel 102 is disposed in the furnace chamber 112 and extends along the length direction of the furnace chamber 112 (i.e., the first direction x) through the preheating zone 101, the peak zone 103, and the cooling zone 105 in turn. The delivery device 118 is provided in the delivery channel 102. As one example, the delivery device 118 is a track delivery device. The delivery device 118 is used to deliver a circuit board 180 to be processed through the furnace chamber 112 along the delivery direction, for example, from the left end of the delivery channel 102 into the furnace chamber 112, and after being soldered in the length direction of the furnace chamber 112 (i.e., the first direction x) sequentially through the preheating zone 101, the peak zone 103 and the cooling zone 105, the processed circuit board 180 is output from the right end of the delivery channel 102. The upper surface of the circuit board 180 to be processed is provided with several electronic elements 291 (see FIG. 2D), which are positioned on the solder area of the circuit board 180 to be processed by soldering paste.

In particular, heating elements are provided in the preheating zone 101 and the peak zone 103, respectively, to enable gas in the preheating zone 101 and the peak zone 103 to be heated. In the embodiment as shown in FIG. 1, the preheating zone 101 includes nine heating units 130, i.e. Z01-Z09 units in FIG. 1. The peak region 103 includes three heating units 130, i.e. Z10-Z12 units in FIG. 1. These heating units 130 (i.e., Z01-Z12 units) are disposed side by side in the furnace chamber 112 along the length direction of the furnace chamber 112 (i.e., the first direction x). Units Z01-Z09 and units Z10-Z12 are connected continuously and the temperature gradually increases. These heating units are arranged in sequential order, for example heating units Z10 and Z12 are located on both sides of the heating unit Z11, the heating unit Z10 being between the heating unit Z09 and the heating unit Z11. After the circuit board 180 to be processed is fed into the preheating zone 101, the circuit board 180 is heated and a portion of the flux dispensed in the soldering paste on the circuit board 180 vaporizes. Since the temperature of the peak zone 103 is higher than that of the preheating zone 101, the soldering paste will melt completely in the peak zone 103 when the circuit board 180 is delivered to the peak zone 103. The peak zone 103 is also a region where higher temperature VOCs (e.g., pine fat and resin in the flux) will vaporize.

A cooling element is provided in the cooling zone 105 to enable gas in the cooling zone 105 to be cooled. In the embodiment shown in FIG. 1, four cooling units, i.e., C01-C04 units, are included in the cooling zone 105, which are disposed side-by-side in the furnace chamber 112 along the first direction x. In this embodiment, the C01-C04 units are continuously connected, that is, these cooling units are arranged in sequential order, and the temperature gradually decreases. That is, in the delivery direction of the reflow oven 100, the gas temperature in each heating unit 130 gradually increases and the gas temperature in each cooling unit gradually decreases. After the circuit board 180 is delivered from the peak zone 103 to the cooling zone 105, the soldering paste is cooled on the upper surface of the circuit board 180 and solidified into a solder joint, thereby connecting electronic elements (see the electronic element 291 in FIG. 2D) to the upper surface of the circuit board 180. Notably, the number of preheating zones 101, peak zones 103, and cooling zones 105 of the reflow oven may vary depending on a product to be welded and different welding processes, not limited to the embodiment shown in FIG. 1.

The delivery channel 102 includes a plurality of delivery channel sub-regions 122 disposed side by side along the first direction x and in communication with each other. Each heating unit 130 of the preheating zone 101 and the peak zone 105 includes a respective heating unit upper portion and a heating unit lower portion, the delivery channel sub-region 122 located in the preheating zone 101 and the peak zone 105 being located between the heating unit upper and heating unit lower portions 114, 115 of the respective heating unit. Similarly, the delivery channel sub-regions 122 located in the cooling zone 105 are located between the respective cooling unit upper and lower portions of each cooling unit.

The heating unit 130 includes at least one negative pressure heating unit 110, which as one example is provided in the peak region 103. As one specific example, the number of negative pressure heating units 110 is two, Z11 unit and Z12 unit in the peak region 103, respectively. Each negative pressure heating unit 110 includes a negative pressure heating unit upper portion 114 and a negative pressure heating unit lower portion 115.

The reflow oven 100 further includes a pair of blocking boxes 108 disposed on the left and right ends of the furnace chamber 112, respectively, that is, the outside of the preheating zone 101 and the cooling zone 105. When the reflow oven 100 is using an inert gas (e.g., nitrogen) as the working gas, a pair of blocking boxes 108 are used to block the preheating zone 101 and the cooling zone 105 in the furnace chamber 112 from communicating with the external environment so as to reduce air in the external environment from entering the reflow oven 100 and affecting the soldering quality.

The reflow oven 100 also includes a barrier exhaust zone 109 disposed between the peak zone 103 and the cooling zone 105. The barrier exhaust zone 109 may draw or exhaust gas from the furnace chamber 112, thereby impeding or reducing volatile pollutant containing gas from the peak zone 103 from entering the cooling zone 105, and as an insulation zone isolating the high temperature peak 103 from the low temperature cooling zone 105.

When the circuit board 180 is delivered to the preheating zone 101 and the peak zone 103, the flux in the soldering paste will vaporize, and many factors such as uneven heating or incomplete vaporization may cause vaporized gas inclusions to remain in the soldering paste, so that hollows are entrained in the soldering paste.

When the circuit board 180 continues to be delivered to the cooling zone 105, the soldering paste will cool to form a solder joint with a hollow, affecting solder reliability. Therefore, it is necessary to remove the hollows in the soldering paste before the soldering paste cools down. Applicants have found that the soldering paste in the peak region 103 is in a molten state and thus is able to more easily remove hollows in the soldering paste in the heating unit of the region. In this embodiment, the negative pressure heating unit 110 is used to remove a hollow in the soldering paste of the circuit board 180 when the circuit board 180 is delivered to the delivery channel sub-region 122 between the negative pressure heating unit upper portion 114 and the negative pressure heating unit lower portion 115.

Although in this embodiment, the negative pressure heating unit 110 is Z11 and Z12 units, the negative pressure heating unit may also be set as other heating units in the peak region 103, and the number may also be set as more or less, depending on actual needs and the number of heating units in the peak region 103. Furthermore, in other embodiments, the negative pressure heating unit 110 may also be provided in the preheating zone 101.

The specific structure of the negative pressure heating unit 110 is described in detail below with the Z11 and Z12 units as examples.

FIGS. 2A to 2D show the general structure of two side-by-side negative pressure heating units 110, with FIGS. 2A and 2B being stereoscopic views of the front and back of the two negative pressure heating units 110, FIG. 2C being a top view of the two negative pressure heating units 110, and FIG. 2D being an exploded view of the two negative pressure heating units 110. As shown in FIGS. 2A to 2D, the two negative pressure heating units 110 are arranged side by side in a housing 204 in the first direction x and supported by a bracket 217. The negative pressure heating unit upper portion 114 and the negative pressure heating unit lower portion 115 of each negative pressure heating unit 110 are spaced apart to form the delivery channel sub-region 122. The circuit board 180 to be processed passes sequentially through the delivery channel sub-regions 122 in the first direction x. As an example, in a second direction y perpendicular to the first direction x, the delivery channel sub-region 122 includes a middle region 241 located in the middle and side regions 242 located on both sides of the middle region 241. The circuit board 180 is placed between two tracks 295 of the delivery device 118, that is, the circuit board 180 passes through the delivery channel 102 from the middle region 241 of the delivery channel sub-region 122.

It will be apparent by those skilled in the art that the range of “middle” of the delivery channel sub-region 122 as referred to in this embodiment is determined by the outermost rail of the delivery device 118. For example, in this embodiment, the delivery device 118 includes two tracks 295 forming a middle region 241 therebetween and the two tracks 295 forming two side regions 242 outboard in the y direction. In some other embodiments, the delivery device 118 may include more rails disposed in parallel in the y direction, and support more circuit boards or the like on the rails. The middle region of the delivery channel sub-region refers to the region between the outermost two tracks in the y direction and the side regions refers to the regions outside the two tracks. Moreover, the “negative pressure” in the negative pressure heating unit 110 referred to in this application is for the pressure received by an electronic element 291 above the circuit board 180, and the negative pressure heating unit 110 refers to the heating unit receiving pressure above the middle region 241 as negative pressure. The pressure received over the side regions 242 in the negative pressure heating unit 110 is positive pressure, and in other heating units not the negative pressure heating unit 110, the pressure received over the middle region 241 is also positive pressure.

A heating element 221 is provided in the negative pressure heating unit 110 to heat the gas in the negative pressure heating unit 110. In this embodiment, the heating element 221 is provided in the respective negative pressure heating unit lower portion 115, and the heating element in this embodiment is a heating rod. The heating element 221 extends from an exterior of the rear side of the negative pressure heating unit lower portion 115 through the housing 204 into the interior of the negative pressure heating unit lower portion 115 to heat the internal gas of the negative pressure heating unit lower portion 115 such that the internal gas reaches a predetermined temperature. The front end of the heating element 221 is supported inside the negative pressure heating unit lower portion 115 by a heating element support 226. It will be apparent by those skilled in the art that in some other embodiments, the negative pressure heating unit upper portion 114 may also be provided with a heating element to provide a greater amount of heat.

An upper fan 219 is provided in each negative pressure heating unit upper portion 114, and a lower fan 220 is provided in each negative pressure heating unit lower portion 115. The upper fan 219 and the lower fan 220 collectively drive the internal circulating flow of gas inside the negative pressure heating unit 110 such that the temperature of the gas inside the negative pressure heating unit 110 is uniform.

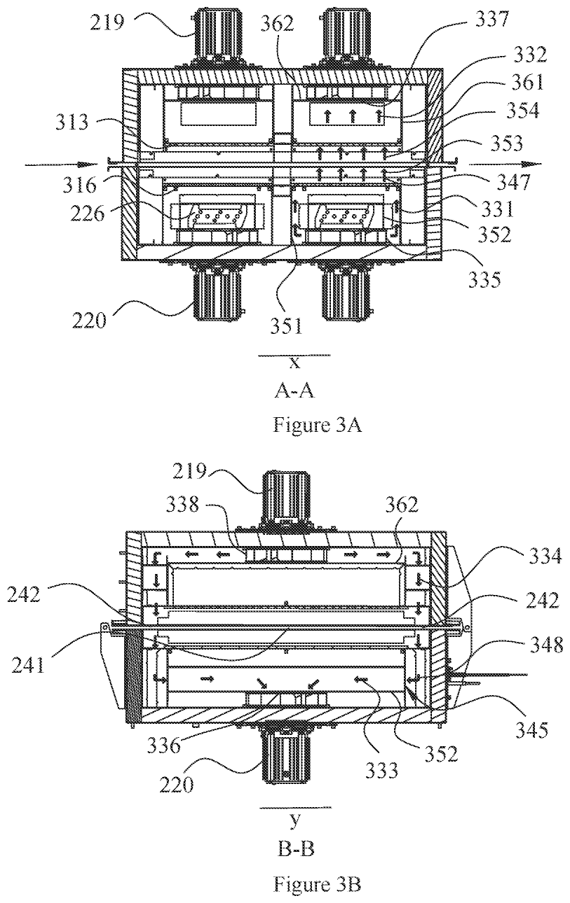

FIGS. 3A and 3B show more specific structures of the two side-by-side arranged negative pressure heating units 110 to illustrate the passage of gas flow inside the negative pressure heating units 110. FIG. 3A shows a cross-sectional view of the negative pressure heating units 110 along the A-A line and FIG. 3B shows a cross-sectional view of the negative pressure heating unit 110 along the B-B line. To illustrate the direction of gas flow, the circuit board 180 to be processed is hidden in FIGS. 3A and 3B.

As shown in FIGS. 3A and 3B, the upper fan 219 has an upper fan suction port 337 and an upper fan exhaust port 338 located at the bottom, and the upper fan exhaust port 338 surrounds and is disposed above the upper fan suction port 337.

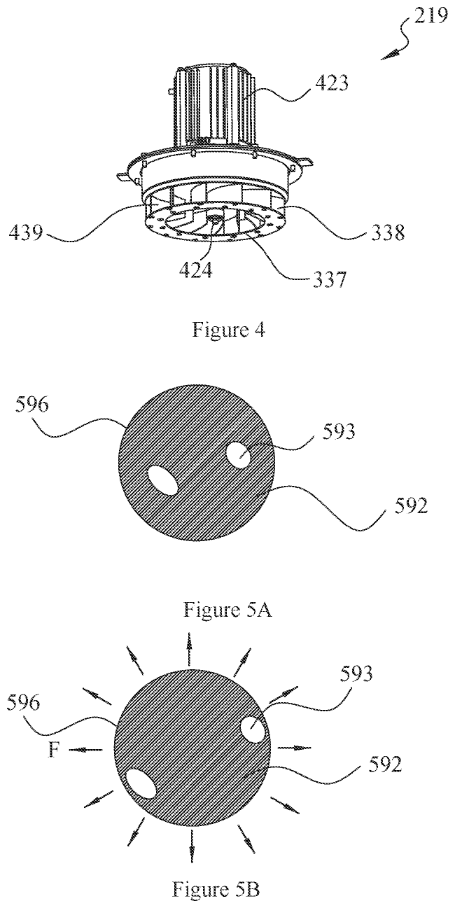

The lower fan 220 has a lower fan suction port 336 and a lower fan exhaust port 335 located at the top, and the lower fan exhaust port 335 surrounds and is disposed below the lower fan suction port 336. As one example, the upper fan 219 and the lower fan 220 are centrifugal fans such that the gas discharged from the exhaust ports of each fan has a certain air pressure, which will be described in detail with reference to FIG. 4. Under the drive of the upper fan 219 and the lower fan 220, the gas inside the negative pressure heating unit 130 is discharged from the exhaust ports of each fan at a certain air pressure, and after flowing within the negative pressure heating unit 130 according to a certain path, the gas is then inhaled into the suction ports of each fan.

In particular, the negative pressure heating unit upper portion 114 includes an upper housing 361 and an upper divider 362. The upper divider 362 is disposed within the upper housing 361 and separates within the upper housing 361 to form an upper suction channel 332 and an upper exhaust channel 334. The negative pressure heating unit lower portion 115 includes a lower housing 351 and a lower divider 352. The lower divider 352 is disposed within the lower housing 351 and separates within the lower housing 351 to form a lower suction channel 333 and a lower exhaust channel 331. The upper suction channel 332 and the lower exhaust channel 331 are shown in the first direction x in FIG. 3A and the upper exhaust channel 334 and the lower suction channel 333 are shown in the second direction y in FIG. 3B. An outlet 353 of the lower exhaust channel 331 is located directly below the middle region 241 of the delivery channel sub-region 122, and an inlet 354 of the upper suction channel 332 is located directly above the middle region 241 of the delivery channel sub-region 122. The upper fan suction port 337 is also located directly above the middle region 241 of the delivery channel sub-region 122 and there is no upper divider 362 between the upper fan suction port and the middle region 241 of the delivery channel sub-region 122 so that the upper suction channel 332 is not blocked. As such, gas exhausted from the lower fan exhaust port335 flows through the lower exhaust channel 331 and blows towards the middle region 241 of the delivery channel sub-region 122 and is then absorbed by the upper suction channel 332 and delivered to the upper fan suction port 337.

Gas exhausted from the upper fan exhaust port 338 is received by the lower fan suction port 336 after flowing sequentially through the upper exhaust channel 334, the side region 242 of the delivery channel sub-region 122, and the lower suction channel 333.

In the embodiments shown in FIGS. 3A and 3B, the negative pressure heating unit upper portion 114 and the negative pressure heating unit lower portion 115 of each negative pressure heating unit 110 and the delivery channel sub-region 122 located between the negative pressure heating unit upper portion 114 and the negative pressure heating unit lower portion 115 collectively form a heated gas internal circulation passage 345. The heated gas internal circulation passage 345 includes a backward passage 347 for the heated gas to flow from bottom to top as shown in FIG. 3A, and a forward passage 348 for the heated gas to flow from top to bottom as shown in FIG. 3B. That is, the backward passage 347 includes the lower exhaust channel 331, the middle region 241 of the delivery channel sub-region 122, and the upper suction channel 332, the lower exhaust channel 331 and the upper suction channel 332 communicating through the middle region 241 of the delivery channel sub-region 122. The forward passage 348 includes the lower suction channel 333, the side regions 242 of the delivery channel sub-region 122, and the upper exhaust channel 334, the lower suction channel 333 and the upper exhaust channel 334 communicating through the side regions 242 of the delivery channel sub-region 122. Thus, when the gas in the heated gas inner circulation passage 345 flows through the delivery channel sub-region 122 in different directions, the gas flows through different regions of the delivery channel sub-region 122.

When the circuit board 180 to be processed passes through the middle region 241 of the delivery channel sub-region 122 in the first direction x, the circuit board is located in the backward passage 347 and the gas in the negative pressure heating unit 110 flows from bottom to top. The lower surface of the circuit board 180 is in fluid communication with the lower fan exhaust port 335 of the lower fan 220 through the lower exhaust channel 331, so the air pressure below the circuit board 180 is positive pressure. The upper surface of the circuit board 180 is in fluid communication with the upper fan suction port 337 of the upper fan 219 through the upper suction channel 332, so the air pressure above the circuit board 180 is negative pressure. The gas pressure under the circuit board 180 acts on the lower surface of the circuit board 180 such that the pressure of the lower surface of the circuit board 180 is generally uniform upwards throughout. The gas pressure above the circuit board 180 acts on the upper surface of the circuit board 180 such that the suction of the upper surface of the circuit board 180 is generally uniform upwards throughout. In the embodiment of the present application, the gas pressure above the circuit board 180 is approximately ( −0.001 to −0.01) atm (i.e., −0.001 to −0.01 atmospheric pressure). At this air pressure, the entrained hollows within the soldering paste above the circuit board 180 are subject to suction and can be expelled, and the circuit board 180 is not blown by the airflow in the backward passage 347.

Moreover, there is no upper divider 362 between the upper fan suction port 337 and the middle region 241 of the delivery channel sub-region 122, which can cause the suction of the upper fan suction port 337 to act more directly on the upper surface of the circuit board 180, thereby better expelling the entrained hollows within the soldering paste.

Referring to FIG. 3A, the heating element support 226 is disposed in the negative pressure heating unit lower portion 115 and supported on the lower divider 352. The heating element support 226 is used to secure the end of the heating element 221 after the heating element 221 extends into the negative pressure heating unit lower portion 115. This allows the heating element 221 to be fixed even if its length is long. In some other embodiments, a heating element and a heating element support may also be provided in the negative pressure heating unit upper portion 114, and the heating element support may be supported on the upper divider 362.

The negative pressure heating unit 110 further includes an upper multiwell plate 313 and a lower multiwell plate 316, the upper multiwell plate 313 and the lower multiwell plate 316 being uniformly disposed with a plurality of apertures. The upper multiwell plate 313 is disposed in the negative pressure heating unit upper portion 114 and is disposed at the inlet 354 of the upper suction channel 332. The upper multiwell plate 313 is disposed such that gas flowing through the middle region 241 of the delivery channel sub-region 122 needs to flow through the upper multiwell plate 313 before it enters the upper suction channel 332 to evenly suck gas into the upper suction channel 332 from the middle region 241 of the delivery channel sub-region 122. The lower multiwell plate 316 is provided in the negative pressure heating unit lower portion 115 and is provided at the outlet 353 of the lower exhaust channel 331. The lower multiwell plate 316 is disposed such that gas discharged from the lower exhaust channel 331 needs to flow through the lower multiwell plate 316 before it flows to the middle region 241 of the delivery channel sub-region 122 to evenly diffuse gas in the lower exhaust channel 331 towards the middle region 241 of the delivery channel sub-region 122. By providing the upper multiwell plate 313 and the lower multiwell plate 316, the gas temperature at the middle region 241 of the delivery channel sub-region 122 is generally uniform, and the pressure and suction received by the circuit board 180 in the middle region 241 of the delivery channel sub-region 122 is also generally uniform.

FIG. 4 illustrates a stereoscopic structure of the upper fan 219 of the present application, the lower fan 220 having a similar structure, which is not repeated herein. As shown in FIG. 4, the upper fan 219 is a centrifugal fan. The upper fan 219 has a motor part 423 and a spool 424 connected to the motor part 423. The upper fan 219 also includes a plurality of blades 439 disposed around and connected to the spool 424 spaced apart. The motor part 423 drives the spool 424 to rotate, which causes the blade 439 to rotate about the axis of the spool 424 when the spool 424 is rotated. The upper fan suction port 337 forms at the bottom of the upper fan 219 and gas can enter among these blades 439 from the upper fan suction port 337. These openings spaced in the circumferential direction by adjacent blades 439 form the upper fan exhaust ports 338 from which gas can be discharged.

When the motor part 423 drives the spool 424 to rotate, gas enters among the blades 439 axially along the spool 424 from the upper fan suction port 337 at the bottom of the upper fan 219, and the rotation of the blades 439 increases the gas pressure and changes the gas flow direction to radial so that the gas is discharged from the upper fan exhaust port 338. As such, the gas discharged from the lower fan exhaust port 335 has a certain positive pressure, and the gas absorbed from the upper fan suction port 337 has a certain negative pressure.

FIGS. 5A and 5B are structural schematic diagrams of a soldering paste with hollows for illustrating the process of removing or expelling hollows from the soldering paste of the present application. As shown in FIG. 5A, the interior of the soldering paste 592 is interspersed with a hollow 593. Because the soldering paste 592 has a certain amount of tackiness, the air pressure inside the hollow 593 is not sufficient to overcome the resistance caused by the tackiness of the soldering paste 592 and cannot move outwardly to the soldering paste 592. Therefore, when the soldering paste 592 is not subject to external force, the hollow 593 cannot be expelled from the soldering paste 592.

As shown in FIG. 5B, when a uniform suction force F is applied around the soldering paste, the hollow 593 having a certain pressure is able to move towards the outer surface 596 of the soldering paste 592 under the action of both inner and outer air pressures until the hollow 593 moves from the interior of the soldering paste 592 to the outer surface 596 that meets the exterior, is cracked and expelled from the soldering paste 592.

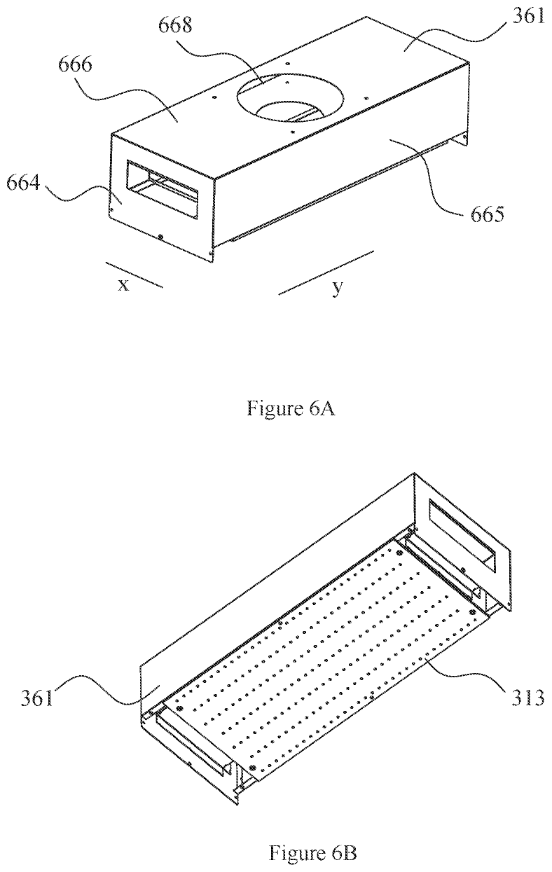

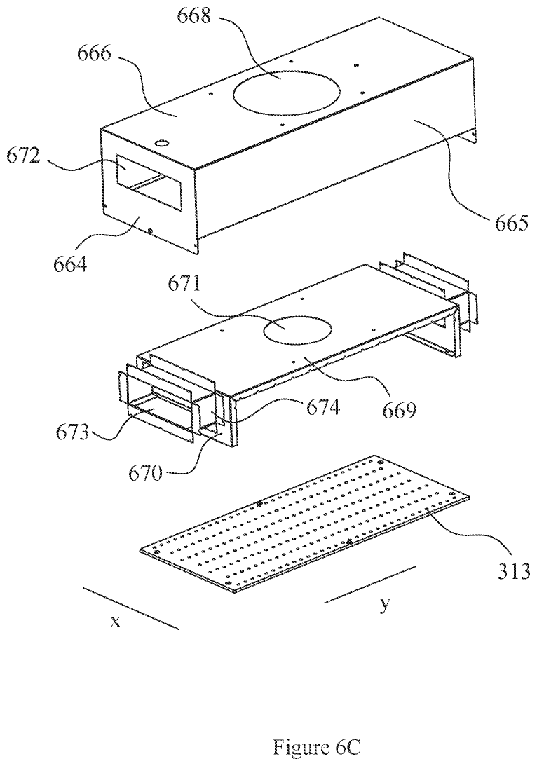

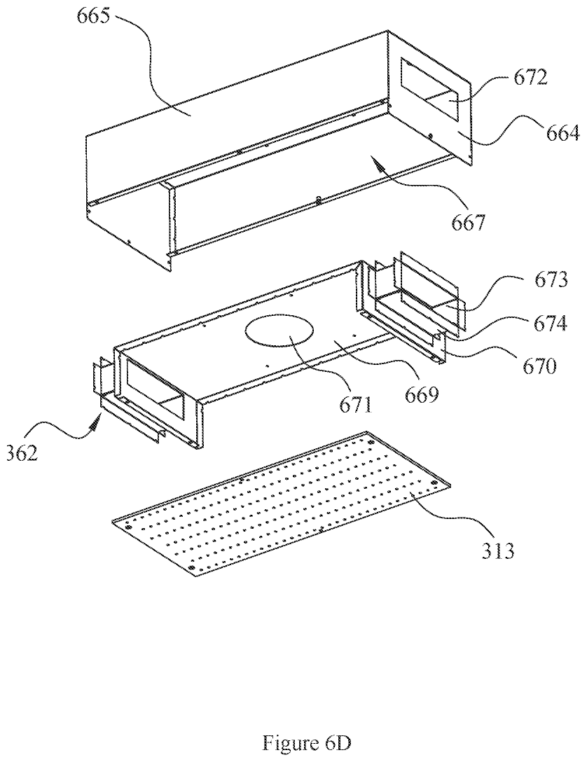

FIGS. 6A to 6D show specific structures of the negative pressure heating unit upper portion 114 according to one embodiment of the present application. FIG. 6A is a perspective structural diagram of the negative pressure heating unit upper portion 114, FIG. 6B is a perspective structural diagram of the negative pressure heating unit upper portion 114, FIG. 6C is an exploded view of the negative pressure heating unit upper portion 114, and FIG. 6D is an exploded view of the negative pressure heating unit upper portion 114.

As shown in FIGS. 6A to 6D, the upper housing 361 of the negative pressure heating unit upper portion 114 is in the shape of a rectangular box body having a bottom opening 667 having a width direction that coincides with the first direction x and a length direction that coincides with the second direction y. The upper housing 361 includes a pair of first direction upper side walls 664, a pair of second direction upper side walls 665, and an upper top wall 666, which are connected to each other. The pair of first direction upper side walls 664 extend along the first direction x and the pair of second direction upper side walls 665 extend along the second direction y. The upper top wall 666 has a fan receiving port 668. The upper fan 219 is mounted on the upper top wall 666, its upper fan exhaust port 338 and the upper fan suction port 337 extend through the fan receiving port 668 below the upper top wall 666 from top to bottom, and its motor part is disposed on the upper top wall 666.

The upper divider 362 includes a transverse partition 669 and a pair of vertical partitions 670. The width direction of the transverse partition 669 is the first direction x and its length direction is the second direction y. The pair of vertical partitions 670 are located below the transverse partition 669 and are connected to both ends of the transverse partition 669 in the second direction y. In this embodiment, the transverse partition 669 is generally parallel to and spaced by a certain distance from the upper top wall 666 of the upper housing 361, the pair of vertical partitions 670 are generally parallel to and spaced by a certain distance from the pair of first direction upper side walls 664, and each vertical partition 670 is connected to the pair of second direction upper side walls 665. In this way, the upper suction channel 332 and the upper exhaust channel 334 can be formed by the upper divider 362 and the upper housing 361.

In particular, the transverse partition 669 extends along the first direction x to be connected with the pair of second direction upper side walls 665. The transverse partition 669 has an upper fan opening 671 to which the upper fan suction port 337 of the upper fan 219 is connected so that the upper fan suction port 337 is in fluid communication with the space below the transverse partition 669 through the upper fan opening 671. The pair of vertical partitions 670 are formed extending downwardly from the edges of both ends of the transverse partition 669 in the second direction y, respectively, and extend along the first direction x to be connected with the pair of second direction upper side walls 665. As such, the transverse partition 669, the pair of vertical partitions 670, and the pair of second direction upper side walls 665 collectively form the upper suction channel 332. The upper fan opening 671 forms an outlet of the upper suction channel 332.

The lower fan exhaust port 335 of the upper fan 219 is disposed between the transverse partition 669 and the upper top wall 666 and is in communication with the upper exhaust channel 334. As such, the space spaced between the transverse partition 669 and the upper top wall 666 forms a part of the upper exhaust channel 334, and the space spaced between the pair of vertical partitions 670 and the pair of first direction upper side walls 664 forms another part of the upper exhaust channel 334.

After the gas in the upper exhaust channel 334 is discharged from the lower fan exhaust port 335, the gas enters the space between the transverse partition 669 and the upper top wall 666 and flows through the space between the pair of vertical partitions 670 and the pair of first direction upper side walls 664 to the side region 242 of the delivery channel sub-region 122.

After the gas in the upper suction channel 332 flows out of the middle region 241 of the delivery channel sub-region 122, the gas enters the space above the transverse partition 669 and is then received by the upper fan suction port 337.

The upper multiwell plate 313 is connected at the bottom of the upper housing 361. In this embodiment, the upper multiwell plate 313 is connected with the pair of vertical partitions 670 in the second direction y and the upper multiwell plate 313 is connected with the pair of second direction upper side walls 665 in the first direction x. In this way, the gas needs to flow through the upper multiwell plate 313 before being delivered to the upper suction channel 332 through the middle region 241 of the delivery channel sub-region 122, enabling the gas to be uniformly delivered from the middle region 241 to the upper suction channel 332.

A housing insertion port 672 is provided on one of the first direction upper side walls 664 of the upper housing 361. The upper divider 362 further includes a pair of heating element insertion ports 673, which are respectively provided on the pair of vertical partitions 670. The upper divider 362 further includes a pair of spacer retainers 674 disposed around the pair of heating element insertion ports 673, respectively, and between the pair of vertical partitions 670 and the corresponding first direction top side walls 664. The position of the housing insertion port 672 corresponds to the position of the pair of heating element insertion ports 673 to collectively receive the heating element 221. Thus, the heating element 221 is capable of passing through the housing insertion port 672 and the heating element insertion port 673 to extend over the transverse partition 669. Furthermore, the spacer ring 674 can also isolate the heating element insertion port 673 from the upper exhaust channel 334 so that the upper suction channel 332 and the upper exhaust channel 334 cannot communicate with each other through the heating element insertion port 673, whereby the upper suction channel 332 can also be isolated from the upper exhaust channel 334.

It can be understood that those skilled in the art can set other upper housing and upper divider structures according to specific needs, as long as the upper suction channel and upper exhaust channel corresponding to the delivery channel sub-region can be formed.

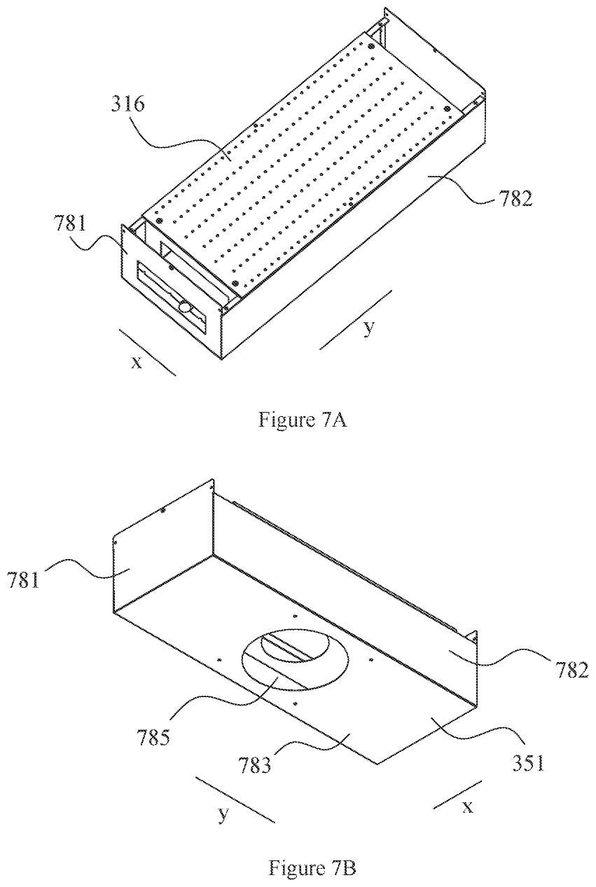

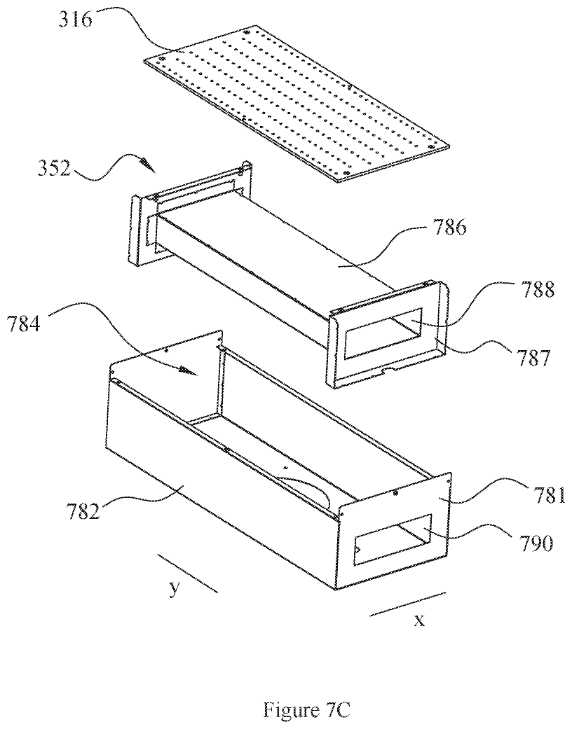

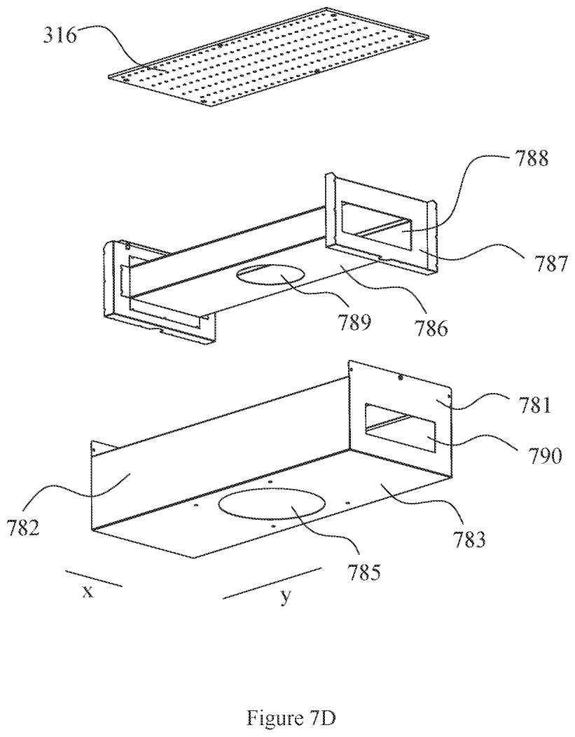

FIGS. 7A to 7D show specific structures of the negative pressure heating unit lower portion 115 according to one embodiment of the present application. Here, FIG. 7A is a perspective view of the negative pressure heating unit lower portion 115 viewed from top down, FIG. 7B is a perspective view of the negative pressure heating unit lower portion 115 viewed from top down, FIG. 7C is an exploded view of the heating unit lower portion 115 viewed from top down, and FIG. 7D is an exploded view of the heating unit lower portion 115 viewed from bottom up.

As shown in FIGS. 7A to 7D, the lower housing 351 of the negative pressure heating unit lower portion 115 is generally in the shape of a rectangular box body having a top opening 784 having a width direction that coincides with the first direction x and a length direction that coincides with the second direction y. The lower housing 351 includes a pair of first direction lower side walls 781, a pair of second direction lower side walls 782, and a lower bottom wall 783 that are mutually connected. The pair of first direction lower side walls 781 extend along the first direction x and the pair of second direction lower side walls 782 extend along the second direction y. The lower bottom wall 783 has a fan receiving port 785. The lower fan 220 is mounted on the lower bottom wall 783 with the lower fan exhaust port 335 and the lower fan suction port 336 extending directly above the lower bottom wall 783 through the fan receiving port 785 from bottom to top with its motor part disposed below the lower bottom wall 783.

The lower divider 352 includes a partition box body 786 and a pair of partition flanges 787. The partition box body 786 is roughly rectangular box body shaped with its width direction in the first direction x and its length direction in the second direction y. The partition box body 786 has a pair of box body openings 788 at both front and rear ends in the second direction y, the pair of partition flanges 787 being respectively disposed around the pair of box body openings 788 and extending outwardly from the partition box body 786. In this embodiment, the individual walls of the partition box body 786 are generally parallel to the individual walls of the lower housing 351, but smaller in size than the lower housing 351. A pair of side walls extending in the second direction y of the partition box body 786 is generally parallel and spaced a certain distance from the pair of second direction lower side walls 782 of the lower housing 351, the top and bottom of the partition box body 786 are generally parallel to the lower bottom wall 783 of the lower housing 351, and the bottom is spaced by a certain distance from the lower bottom wall 783. A pair of partition flanges 787 are generally parallel to and spaced a certain distance from the pair of first direction lower side walls 781 of the lower housing 351, and the pair of partition flanges 787 are connected to the second direction lower side walls 782 and the lower bottom wall 783. As such, the lower suction channel 333 and the lower exhaust channel 331 can be formed by the lower partition 352 and the lower housing 351.

Specifically, the bottom of the partition box body 786 has a lower fan opening 789 to which the lower fan suction port 336 of the lower fan 220 is connected so that the lower fan suction port 336 is in fluid communication with the interior of the partition box body 786 through the lower fan opening 789. The pair of partition flanges 787 respectively extend downwardly from the outer edge of the box body opening 788 to connect with the lower bottom wall 783 of the lower housing 351 and extend in the first direction x to connect with the pair of second direction lower side walls 782. As such, the space between the pair of partition flanges 787 and the pair of first direction bottom side walls 781 forms a part of the lower suction channel 333, and the interior of the partition box body 786 forms another part of the lower suction channel 333. The lower fan opening 789 forms an outlet of the lower suction channel 333.

The lower fan exhaust port 335 of the lower fan 220 is disposed between the bottom of the partition box body 786 and the lower bottom wall 783 and is in communication with the lower exhaust channel 331. As such, the space spaced between the bottom of the partition box body 786 and the lower bottom wall 783 of the lower housing 351, and the space spaced between the pair of side walls extending in the second direction y of the partition box body 786 and the pair of second direction lower side walls 782 of the lower housing 351 collectively form the lower exhaust channel 331.

After the gas in the lower exhaust channel 331 is discharged from the lower fan exhaust port 335, the gas enters the space between the partition box body 786 and the lower bottom wall 783 and flows through the space between the partition box body 786 and the pair of second direction lower side walls 782 to the middle region 241 of the delivery channel sub-region 122.

After the gas in the lower suction channel 333 flows out of the side region 242 of the delivery channel sub-region 122, the gas enters the space between the partition flange 787 and the first direction lower side wall 781, and then enters the interior of the partition box body 786 through the box body opening 788 and is finally received by the lower fan suction port 336.

The lower multiwell plate 316 is connected at the top of the lower housing 351. In this embodiment, the lower multiwell plate 316 is connected with the pair of partition flanges 787 in the second direction y and the lower multiwell plate 316 is connected with the pair of second direction lower side walls 782 in the first direction x. In this way, the gas in the lower exhaust channel 331 needs to flow through the lower multiwell plate 316 before being delivered to the middle region 241 of the delivery channel sub-region 122 so that the gas can spread evenly towards the middle region 241.

A housing insertion port 790 is provided on one of the first direction lower side walls 781 of the lower housing 351. The position of the housing insertion port 790 corresponds to the position of the box body opening 788 to collectively receive the heating element 221. Thus, the heating element 221 is able to extend through the housing insertion port 790 and the box body opening 788 into the interior of the partition box body 786. As one example, the other end of the heating element 221 protrudes from the opposite box body opening 788.

It can be understood that those skilled in the art can also set other lower housing and lower partition structures according to specific needs, as long as the lower suction channel and lower exhaust channel corresponding to the delivery channel sub-region can be formed.

In a typical reflow oven, gas from the heating unit upper portion and gas from the heating unit lower portion are each blown towards a middle region of the delivery channel sub-region after being discharged from the respective fan exhaust ports.

Thus, the gases above and below the circuit board form a positive pressure. The positive pressure of the gas above the circuit board is not conducive to expelling the entrained hollows in the soldering paste.

In the reflow oven of the present application, the negative pressure heating unit is included, and by setting the flow directions of the exhaust channel and the suction channel of the negative pressure heating unit upper portion, the gas above the circuit board can form a negative pressure when the circuit board is in the negative pressure heating unit, so as to facilitate the expelling of the entrained hollows in the soldering paste of the circuit board. By disposing the negative pressure heating unit, the number of hollows inside the soldering paste is greatly reduced when the circuit board enters the cooling zone, so the hollows inside the resulting solder joint are greatly reduced, thereby improving the solder quality and yield of the circuit board. The negative pressure heating unit of the present application is disposed in the peak zone in which the soldering paste on the circuit board is already in a molten state, and the hollows inside the soldering paste in the molten state can be more easily discharged relative to the soldering paste in the solid state. In addition, the reflow oven of the present application does not need to newly add a negative pressure device with a complex structure and only needs to change the structure of the upper divider on the basis of the heating unit structure of the existing reflow oven, and the cost of retrofitting is low.

Although the present disclosure has been described in connection with examples of the embodiments outlined above, various alternatives, modifications, variations, improvements, and/or substantial equivalents, whether known or foreseeable now or in the near future, may be apparent to those having at least ordinary skill in the art. In addition, the technical effects and/or technical problems described in the present specification are exemplary and not limiting; therefore, the disclosure in the present specification may be used to solve other technical problems and have other technical effects and/or may solve other technical problems. Therefore, examples of embodiments of the present disclosure as set forth above are intended to be illustrative and not limiting. Various changes may be made without departing from the spirit or scope of the present disclosure. Therefore, the present disclosure is intended to include all known or earlier developed alternatives, modifications, variations, improvements and/or substantial equivalents.

What is claimed is:

1. A reflow oven comprising:
a furnace chamber;
several heating units disposed side-by-side in the furnace chamber along a first direction, the several heating units comprising at least one negative pressure heating unit, each negative pressure heating unit comprising a negative pressure heating unit upper portion and a negative pressure heating unit lower portion; and
a delivery channel extending through the plurality of heating units along the first direction and comprising a plurality of delivery channel sub-regions respectively located between the negative pressure heating unit upper portion and the negative pressure heating unit lower portion of each negative pressure heating unit, the delivery channel sub-regions comprises in a second direction perpendicular to the first direction a middle region for passing a processing element through and side regions located on opposite sides of the middle region;
wherein the negative pressure heating unit upper portion comprises an upper fan, an upper suction channel, and an upper exhaust channel, the upper fan having an upper fan suction port and an upper fan exhaust port;
the negative pressure heating unit lower portion comprises a lower fan, a lower suction channel, and a lower exhaust channel, the lower fan having a lower fan suction port and a lower fan exhaust port;
wherein the upper suction channel, the upper exhaust channel, the lower suction channel, and the lower exhaust channel are configured such that gas discharged from the lower fan exhaust port flows through the lower exhaust channel and blows to the middle region of the delivery channel sub-region, then is sucked by the upper suction channel and delivered to the upper fan suction port, and the gas discharged from the upper fan exhaust port sequentially flows through the upper exhaust channel, the side regions of the delivery channel sub-region and the lower suction channel, and is then received by the lower fan suction port.

2. The reflow oven according to claim 1, wherein:
the negative pressure heating unit upper portion and the negative pressure heating unit lower portion of each negative pressure heating unit and the delivery channel sub-region located between the negative pressure heating unit upper portion and the negative pressure heating unit lower portion collectively form a heated gas internal circulation passage;
wherein the heated gas internal circulation passage comprises a backward passage for heated gas to flow from bottom to top and a forward passage for the heated gas to flow from top to bottom, wherein the backward passage comprises the lower exhaust channel, the middle region of the delivery channel sub-region and the upper suction channel, and the forward passage comprises the upper exhaust channel, the side regions of the delivery channel sub-region and the lower suction channel.

3. The reflow oven according to claim 2, wherein:
the furnace chamber comprises a preheating zone and a peak zone, and the several heating units are disposed in the preheating zone and the peak zone, wherein the at least one negative pressure heating unit is disposed in the peak zone.

4. The reflow oven according to claim 2, wherein:
the pressure within the negative pressure heating unit upper portion is −0.001 to −0.01 atmospheric pressure.

5. The reflow oven according to claim 2, wherein:
the negative pressure heating unit upper portion comprises an upper housing and an upper divider disposed within the upper housing, the upper fan suction port and the upper fan exhaust port are disposed within the upper housing, the upper suction channel and the upper exhaust channel are formed by the upper divider and the upper housing, the inlet of the upper suction channel is located directly above the middle region of the delivery channel sub-region; and
the negative pressure heating unit lower portion comprises a lower housing and a lower divider disposed within the lower housing, and the lower fan suction port and the lower fan exhaust port are disposed within the lower housing, the lower suction channel and the lower exhaust channel are formed by the lower divider and the lower housing, the outlet of the lower exhaust channel is located directly below the middle region of the delivery channel sub-region.

6. The reflow oven according to claim 5, wherein:
the upper fan suction port is located directly above the middle region of the delivery channel sub-region, and there is no upper divider between the upper fan suction port and the middle region of the delivery channel sub-region.

7. The reflow oven according to claim 5, wherein:
the upper housing of the negative pressure heating unit upper portion comprises a pair of first direction side walls extending in the first direction, a pair of second direction side walls extending in the second direction, and an upper top wall, the first direction upper side walls, the second direction upper side walls and the upper top walls being connected to each other such that the upper housing forms a box body shape with a bottom opening, the upper top wall having a fan receiving port; and
the upper divider comprises a transverse partition and a pair of vertical partitions located below the transverse partitions and connected to both ends of the transverse partition in the second direction, the transverse partition having an upper fan opening;
wherein the transverse partition and the pair of vertical partitions are all connected to the pair of second direction upper side walls to collectively form the upper suction channel through the transverse partition, the pair of vertical partitions and the pair of second direction upper side walls, the upper fan opening forming an outlet of the upper suction channel;
wherein the transverse partition is spaced from the upper top wall by a certain distance to form a part of the upper exhaust channel, and the pair of vertical partitions are spaced from the pair of first direction upper side walls by a certain distance, respectively, to form another part of the upper exhaust channel.

8. The reflow oven according to claim 7, wherein:
the upper fan suction port is connected to an upper fan opening of the transverse partition, and the upper fan exhaust port is disposed between the transverse partition and the upper top wall and is in communication with the upper exhaust channel.

9. The reflow oven according to claim 7, wherein:
the upper housing comprises a housing insertion port disposed on one of the pair of first direction upper side walls;
the upper divider further comprises a pair of heating element insertion ports disposed on the pair of vertical partitions, respectively; and
the upper divider further comprises a pair of spacer retainers disposed around the pair of heating element insertion ports respectively and between the pair of vertical partitions and the first direction upper side walls to isolate the upper suction channel and the upper exhaust channel while being able to receive a heating element.

10. The reflow oven according to claim 5, wherein:
the lower housing of the negative pressure heating unit lower portion comprises a pair of first direction lower side walls extending in the first direction, a pair of second direction lower side walls extending in a second direction, and a lower bottom wall, the first direction lower side walls, the second direction lower side walls and the lower bottom wall being connected to each other such that the lower housing forms a box body shape with a top opening, the lower bottom wall having a fan receiving port;
the lower divider comprises a partition box body and a pair of partition flanges, the partition box body having a pair of box body openings at both ends in the second direction, the pair of partition flanges disposed around and extending outwardly from the pair of box body openings respectively, the bottom of the partition box body having a lower fan opening;
the pair of partition flanges are connected to the pair of second direction lower side walls and the lower bottom wall, respectively, and are spaced from the pair of first direction lower side walls by a certain distance to form a part of the lower suction channel, another part of the lower suction channel being formed inside the partition box body, and the lower fan opening forming an outlet of the lower suction channel; and
the partition box body is spaced apart from the lower bottom wall and the pair of second direction lower side walls to form the lower exhaust channel between the pair of partition flanges, the partition box body and the lower housing.

11. The reflow oven according to claim 10, wherein:
the lower housing comprises a housing insertion port disposed on one of the pair of first direction lower side walls, and the housing insertion port and the pair of box body openings are provided to collectively receive a heating element.

12. The reflow oven according to claim 11, wherein:
the lower fan suction port is connected to a lower fan opening of the partition box body, and the lower fan exhaust port is disposed between the partition box body and the lower bottom wall and in communication with the lower exhaust channel.
